(19) United States
(12) Patent Application Publication
(10) Pub. No.: US 2023/0382652 A1
(43) Pub. Date: Nov. 30, 2023

(54) CONVEYING METHOD AND CONVEYING APPARATUS FOR GOODS

(71) Applicant: Dürkopp Fördertechnik GmbH, Bielefeld (DE)

(72) Inventors: Dirk SIEKSMEIER, Spenge (DE); Axel KLEINEKATHÖFER, Bielefeld (DE); Dirk MEIER, Detmold (DE); Pascal REHM, Bielefeld (DE)

(21) Appl. No.: 18/322,454

(22) Filed: May 23, 2023

(30) Foreign Application Priority Data
May 24, 2022 (DE) 10 2022 205 211.0

(51) Int. Cl. B65G 43/00; B65G 17/20

(52) U.S. Cl. CPC B65G 43/00; B65G 17/20

(57) ABSTRACT

A conveying method for goods comprises the method steps of requesting an order from a goods sink, wherein the order comprises at least one product which is an ordered product, requesting the at least one ordered product from a first endless conveyor to which the goods sink is directly connected in terms of conveying technology, requesting and automatically transferring the at least one ordered product from a consolidation storage unit, which is connected upstream of the first endless conveyor and has a circulating conveyor line, into the first endless conveyor, and conveying and discharging the at least one requested ordered product to the goods sink.

### CROSS-REFERENCES TO RELATED APPLICATIONS

This application claims priority to German Patent Application No. DE 10 2022 205 211.0, filed May 24, 2022, the content of which is incorporated herein by reference in its entirety as if fully set forth herein.

### FIELD OF THE INVENTION

The invention relates to a conveying method and a conveying apparatus for goods.

### BACKGROUND OF THE INVENTION

When processing customer orders in a conveyor system, individual goods are conveyed from a warehouse, compiled into orders, in particular sorted, transported to an outgoing goods zone and dispatched. Sorting can be carried out by means of a so-called matrix sorter, with which a compilation of orders is achieved by sequencing the individual goods. A matrix sorter is a sorter with multiple sorting stages that are arranged one behind the other in the goods conveying direction. Each sorting stage has a plurality of sorting tracks, wherein it is possible to feed and discharge goods into and out of the sorting stages in each sorting track. In particular, sorting is performed by applying different sorting criteria for each sorting stage. With the matrix sorter, not only the goods are determined with regard to their belonging together in orders, but also the sequence of the goods within an order. The sequence of the goods within an order is irrelevant, especially in the mail order business. The relevant process steps and a goods buffer of the matrix sorter are not necessary.

Alternatively, sorting can be carried out by means of a comb sorter, in which the goods are fed into sorting lines in a targeted manner starting from a feed track. The number of orders to be processed simultaneously corresponds to the number of goods sinks, i.e., packing places. The disadvantage is that a large number of goods sinks is required for a high goods throughput. The required investment and space for a conveyor system of this type are large.

### SUMMARY OF THE INVENTION

It is an object of the present invention to simplify the, in particular order-oriented, conveyance of goods to goods sinks, in particular to reduce the number of method steps and/or the throughput time of the goods in a conveying apparatus and, in particular, to reduce the number of goods sinks required.

This object is achieved according to the invention by a conveying method for goods comprising the method steps of requesting an order from a goods sink, wherein the order comprises at least one product which is an ordered product, requesting the at least one ordered product from a first endless conveyor, to which the goods sink is directly connected in terms of conveying technology, requesting and automatically transferring the at least one ordered product from a consolidation storage unit, which is connected upstream of the first endless conveyor and has a circulating conveyor line, into the first endless conveyor and conveying and discharging the at least one ordered product to the goods sink, as well as by a conveying apparatus for goods comprising a consolidation storage unit which has a circulating conveyor line, a first endless conveyor which is arranged downstream of the consolidation storage unit, at least one goods sink which is directly connected in terms of conveying technology to the first endless conveyor, a control unit which is designed to execute the conveying method.

Goods are requested, i.e., pulled, from at least one goods sink from an upstream conveying stage. The invention in particular relates to a multi-stage and in particular pull-based sorting of the goods, in particular for different orders. The at least one goods sink is in particular a packing place. The packing place is in particular connected in terms of conveying technology to an outgoing goods zone. The idea according to the invention thus differs from methods according to the prior art, in which the goods are pushed from a warehouse to the goods sinks.

In particular, it has been recognized that neither the succession of the goods within an order, a so-called sequence, nor the continuous conveyance of goods of an order in the conveying apparatus, a so-called cohesion, are necessary. According to the invention, cohesion can take place in a method step that is as late as possible, and in particular the last method step, when the goods are discharged from the first endless conveyor to the goods sink. Cohesion is not required in any of the previous method steps. This increases the flexibility in conveying the goods. The conveying method is thus simplified.

Furthermore, it has been recognized that a low order throughput time is made possible with a high goods performance, i.e., a high goods throughput. In particular, the invention combines the respective advantages of a matrix sorter with those of a comb sorter without adopting their inherent disadvantages.

A further finding of the invention is based on the fact that the goods are sorted at least in a consolidation storage unit which has a circulating conveyor line. This means that the goods in the consolidation storage unit are conveyed in a circulating manner and can be sorted by selective introduction into the consolidation storage unit and/or selective discharge from the consolidation storage unit. In particular, the consolidation storage unit forms a first conveying stage. Upstream of the consolidation storage unit is in particular at least one loading place at which individual goods are fed into a conveyor container. The consolidation storage unit is a goods storage unit and in particular a warehouse in which the individual goods are dynamically stored in circulation.

Since both the first endless conveyor and the consolidation storage unit, i.e., in particular the first and the last conveying stage, are each designed as circulating conveyors which form circulating storage units, in particular with random access to each ordered product, the processing sequence of the goods can be changed in these conveying stages by allowing goods of different orders to overtake each other when being transferred from one conveying stage to the next.

In particular, exactly one product is conveyed with each conveyor container. A conveyor container is in particular a conveyor bag, which is in particular transported in a suspended manner in the conveying apparatus. The conveying apparatus is in particular an overhead conveyor. A conveyor bag of this type is known, for example, from DE 10 2018 201 675 A1 or from DE 10 2018 201 676 A1. Alternatively, the conveyor container may also be a container for lying goods, in particular a crate or a cardboard box. In this case, the conveying apparatus is a horizontal conveyor, in particular a belt conveyor or band conveyor.

The goods are initially requested by the at least one goods sink from a first endless conveyor, which is connected downstream of the consolidation storage unit in the goods conveying direction. The first endless conveyor constitutes a downstream, in particular last, conveying stage. In terms of conveying technology, the at least one goods sink is connected directly to the endless conveyor. The goods requested from the consolidation storage unit are conveyed by the first endless conveyor and delivered to the respective goods sink, in particular in an order-oriented manner. The goods are automatically transferred from the consolidation storage unit to the first endless conveyor. Such a method is efficient. Human and/or manual interactions are dispensable.

It has been found that in a multi-stage conveying method, a transfer of goods from an upstream conveying stage to a downstream conveying stage is particularly advantageous if the transfer is triggered in each case by the downstream conveying stage. The downstream conveying stage defines and generates a demand for goods. Based on this demand for goods, the goods required for this are requested from the upstream conveying stage. The respective request for goods is made in particular from a conveying stage to the respective upstream conveying stage and in particular multiple times back to a goods storage unit or warehouse. In particular, overfilling of a conveying stage and a resulting backlog in the flow of goods can be avoided.

In particular, it has been recognized that it is advantageous if exactly one order is allocated to the at least one goods sink. This allocated order implies a demand for goods, in particular ordered goods, wherein these ordered goods are requested by the goods sink from the first endless conveyor. The request from the goods sink to the first endless conveyor generates the demand for goods in the first endless conveyor. Accordingly, this demand for goods is passed on from the first endless conveyor to the consolidation storage unit. The conveying method is pull-based. The goods are pulled through the various conveying stages from the goods sink.

A method of this type can be carried out quickly and efficiently. With a corresponding conveying apparatus, the number and the space required for buffer storage units and/or for goods sinks, i.e., packing places, can be reduced. The investment costs are reduced. The required space is reduced.

Another finding is based on the fact that the consolidation storage unit enables a decoupling between a loading process at a loading place and a packing process at a packing place. The loading process means that the conveyor containers that are loaded with the individual goods are conveyed, i.e., pushed, into the consolidation storage unit. The loading process is a so-called push process. The packing of the goods at the packing places, i.e., at the goods sinks, is pull-based. The consolidation storage unit enables the logistic decoupling and decoupling in terms of conveying technology of the push-based loading and the pull-based packing. This decoupling enables efficient operation, in particular batch operation, of a storage stage, which in particular is located upstream of the loading places. The storage stage comprises in particular a shuttle-based and/or a manual picking warehouse.

In particular, it has been found that the goods intake capacity of the various conveying stages decreases with an increase in the conveying stage degree. This means that a conveying stage of a higher order has a lower goods intake capacity. Accordingly, the turnaround time of the various conveying stages is different and decreases for downstream conveying stages. In particular, the first endless conveyor has a goods intake capacity of approximately 150 to 300 items and in particular 180 to 250 items. The consolidation storage unit has a goods intake capacity of at least 1,000 items, in particular at least 5,000 items and in particular up to 10,000 items or more.

The endless conveyor is designed to circulate endlessly, i.e., is closed in terms of conveying technology. It is advantageous if the first endless conveyor has a first conveyor strand and a second conveyor strand, wherein only the first conveyor strand has a fixed conveyor container entrainment. The second conveyor strand does not have a fixed conveyor container entrainment. The second conveyor strand has a buffer function. The second conveyor strand in particular serves to recirculate the goods and in particular as a bypass section in the first endless conveyor with respect to the first conveyor strand. In particular, the closed first endless conveyor is formed by the first conveyor strand and the second conveyor strand. In this case, the first endless conveyor does not have any other conveyor strands.

It is also possible for the first endless conveyor to have more than two conveyor strands, wherein there may be a plurality of first conveyor strands, i.e., with fixed conveyor container entrainment, and/or a plurality of second conveyor strands without fixed conveyor container entrainment. It is essential that only the first conveyor strands are designed with a fixed conveyor container entrainment. Accordingly, however, more than one conveyor strand, namely a plurality of first conveyor strands, can each have a fixed conveyor container entrainment.

It has been found that with the first endless conveyor, and in particular with the second conveyor strand without fixed conveyor container entrainment, it is possible to decouple the conveyor containers and the conveyor container entrainment. This makes it possible, in particular, to engage the conveyor containers in the flow of goods of the endless conveyor at an adjustable distance, i.e., in terms of conveying technology, to feed them into the endless conveyor. Gaps in the, in particular recirculated, flow of goods, which arise in particular due to the discharge of goods to the goods sinks, can be closed by at least temporarily accumulating the goods in the second conveyor strand and/or by selectively engaging the goods from the at least one goods source. It is possible to post-compact the flow of goods.

The conveyor container and a conveyor drive which drives the conveyor containers in the first endless conveyor can be decoupled at least in sections and/or at least temporarily, i.e., are not firmly connected to one another. This decoupling takes place along the second conveyor strand.

The first endless conveyor itself has a buffer function and, in particular, enables flexible allocation of the goods in the first endless conveyor to the goods sinks. Since the first endless conveyor is directly connected to multiple goods sinks, a rigid allocation of goods to exactly one goods sink is dispensable. The method can be implemented flexibly.

The method is particularly suitable for orderless quantity distribution and/or order-based distribution, which is used for e-commerce orders, for example. In order-based distribution, a quantity of goods that constitutes an order is allocated to a goods sink instead of individual goods. An order comprises at least one product and in particular a number of goods, wherein the goods are in particular different goods, i.e., different types of goods. In particular, the goods sinks each have a plurality of goods locations. Each goods location constitutes a buffer for at least one ordered product.

The goods conveyed in the conveyor containers can be clearly identified. For this purpose, the conveyor containers have identification means known per se, in particular RFID chips and/or machine-readable codes, in particular bar codes or QR codes. Reading devices are arranged along a goods conveying direction of the conveying apparatus, which serve to read the identification means. The conveyor containers with the goods conveyed therein can be tracked in the conveying apparatus. In particular, the position of each conveyor container within the conveying apparatus can be determined.

In the conveying method according to the invention, the goods are conveyed in multiple stages, namely from the first conveying stage, the consolidation storage unit, into at least one subsequent conveying stage. This means that there is at least one further conveying stage, namely the first endless conveyor. Further conveying stages, in particular further endless conveyors, can be arranged between the consolidation storage unit and the first endless conveyor. The individual conveying stages are connected to each other in terms of conveying technology, in particular by means of linear conveying lines. The linear conveying lines enable conveyance from a conveying stage of a lower order to a conveying stage of the next higher order. A reverse conveying direction, i.e., from a conveying stage of a higher order to a conveying stage of a lower order, is in particular not provided. Within the respective conveying stages, the goods are in particular conveyed in endless circulation. Each conveying stage constitutes a buffer storage unit. The goods are not sorted within the conveying stages. Sorting of the goods is carried out by selective introduction and discharge into or out of a respective conveying stage.

A conveying method in which the goods are conveyed in conveyor containers, in particular individually, enables an advantageous handling, in particular conveying, of the goods. In particular, a continuous conveyance of goods is possible, in particular a continuous flow of goods.

A method in which the discharge of the ordered goods comprises an, in particular automatic, unloading of the ordered goods from the conveyor containers by means of an unloading unit and/or a discharge of conveyor containers from the first endless conveyor by means of a discharge unit increases in particular the efficiency of automation. In particular, it is possible to perform the delivery of the goods, i.e., the unloading and/or discharge, at a constant conveying speed. It has been recognized that a reduction of the conveying speed in the first endless conveyor is dispensable. The goods are discharged in particular at the nominal speed of the conveyor drive. The method is in particular a continuous conveying method. The method enables increased efficiency, i.e., an increased conveying rate.

A method in which requesting the at least one ordered product is based on the criteria of order quantity, customer of the order and/or order priority, wherein in particular the request criteria can vary for different conveying stages, enables increased flexibility of the goods in the flow of goods, in particular with regard to the sorting of the goods.

A second endless conveyor downstream of the consolidation storage unit (2), from which the at least one ordered product is requested, in particular before it is requested from the consolidation storage unit, arranged in the goods conveying direction between the consolidation storage unit and the first endless conveyor increases the flexibility in the provision of goods. The second endless conveyor has a goods intake capacity of 200 items to 1,000 items, in particular of 300 items to 800 items and in particular of 400 to 600 items.

A method comprising a collection of ordered goods of an order in a conveying stage, in particular in the consolidation storage unit, until this order is complete, enables a consolidation of complete orders in a conveying stage. The consolidation takes place in particular in each conveying stage, in particular for the first time in the consolidation storage unit. In particular, further processing of goods in a conveying stage is only carried out after consolidation has taken place in the respective previous conveying stage. The sorting quality is increased because, in particular, only complete, i.e., consolidated, orders are passed on to the next conveying stage. Possible errors in the feeding of goods into the next conveying stage are compensated for by the consolidation. An incorrect feed may occur in particular due to manual picking.

A method comprising changing the order sequence when requesting goods enables increased flexibility in the sorting process.

A method in which the conveyance of the at least one ordered product into the next conveying stage, in particular into the first endless conveyor, takes place in an order-oriented manner ensures a targeted, in particular order-oriented, conveyance of the goods.

A method in which the at least one ordered product is only conveyed to the next conveying stage if all ordered goods of this order are arranged in the previous conveying stage, in particular in the consolidation storage unit, ensures an improved sorting quality.

A method comprising filling the consolidation storage unit with goods from at least one loading station enables successive filling of the consolidation storage unit. In particular, it is possible to fill the consolidation storage unit starting from multiple loading stations. The loading can be carried out independently of the order processing with a pushing process in that the loaded conveyor containers are conveyed into the consolidation storage unit, in particular in terms of conveying technology independently of the pull-based goods discharge process.

A method comprising random access to all goods, in particular in the first endless conveyor, in the second endless conveyor and/or in the consolidation storage unit and in particular in each conveying stage, increases flexibility in the sorting procedure and in the discharge of goods. In particular, each individual product can be transferred to the next conveying stage independently of the sequence of the goods within a conveying stage.

Random access means that the goods can be stored in and/or removed from the respective conveying stage, i.e., the first endless conveyor, the consolidation storage unit and any further endless conveyors arranged in between. Random storage and/or random removal means that these processes take place independently of the sorting of the goods, i.e., of the sequence of the goods in the flow of goods and/or of the sequence and/or sorting of the goods in the respective conveying stage.

A conveying apparatus for goods comprising a consolidation storage unit which has a circulating conveyor line, a first endless conveyor which is arranged downstream of the consolidation storage unit, at least one goods sink which is directly connected in terms of conveying technology to the first endless conveyor and a control unit which is designed to execute the conveying method has essentially the advantages of the conveying method, reference to which is hereby made. It is essential that two circulating storage units arranged one behind the other can be controlled by means of a control device in such a manner that the conveying method according to the invention can be performed.

A second endless conveyor comprising a second endless conveyor which is arranged between the consolidation storage unit and the first endless conveyor serves in particular as an additional conveying stage between the consolidation storage unit and the first endless conveyor. The second endless conveyor simplifies in particular the transition from the large consolidation storage unit with a long circulation time to the comparatively small first endless conveyor with a short circulation time. In particular, the second endless conveyor has a structural size and circulation time that falls between the corresponding values of the first endless conveyor and the consolidation storage unit.

A conveying apparatus configured as an overhead conveying apparatus which has, in particular, a conveyor rail and entrainers which are conveyed therein and can each be coupled to a conveyor container enables a particularly efficient conveyance and sorting of the individual goods.

A conveying apparatus configured such that the intake capacity of the first endless conveyor and the consolidation storage unit and in particular of the second endless conveyor decreases as the conveying stage increases enables a targeted concentration of the flow of goods towards the goods sinks.

Both the features indicated above and the features indicated in the following embodiment example of a conveying apparatus according to the invention are each suitable, alone or in combination with one another, for further refining the subject-matter according to the invention. The respective combinations of features do not constitute any restriction with regard to the further embodiments of the subject-matter of the invention, but are essentially merely exemplary in character.

Further features, advantages and details of the invention will be apparent from the following description of an embodiment example with reference to the drawing.

### BRIEF DESCRIPTION OF THE DRAWINGS

FIG. 1 shows a highly schematized illustration of a conveying apparatus according to the invention,

FIG. 2 shows an illustration of the conveying apparatus corresponding to FIG. 1, showing a more detailed view of the first endless conveyor,

FIG. 3 shows an enlarged, partially cut-out side view of a first conveyor strand of the first endless conveyor in FIG. 2.

### DETAILED DESCRIPTION

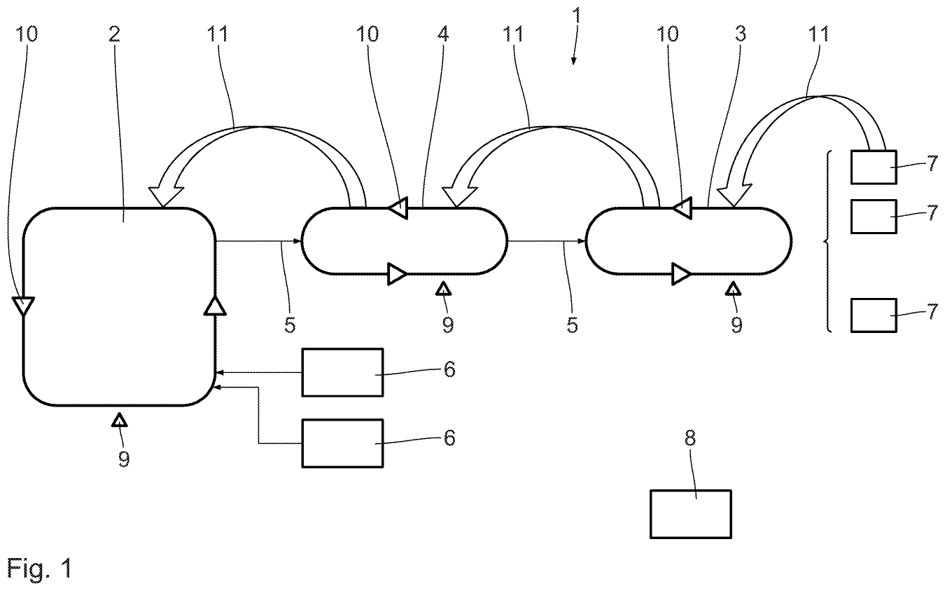

A conveying apparatus marked 1 as a whole in FIG. 1 comprises multiple conveying stages, namely a consolidation storage unit 2 as the first conveying stage and a first endless conveyor 3 as the last conveying stage. Furthermore, a second endless conveyor 4 is arranged between the consolidation storage unit 2 and the first endless conveyor 3. The second endless conveyor 4 is optional, whereby further conveying stages, which can be designed in particular as endless conveyors, can also be arranged in addition to the second endless conveyor 4, in particular between the consolidation storage unit 2 and the first endless conveyor 3.

The conveying stages 2, 3, 4 are each coupled in terms of conveying technology to the next higher conveying stage by means of a conveyor line 5 in order to convey goods from an upstream conveying stage to a downstream conveying stage.

The conveying apparatus 1 is an overhead conveyor.

The various conveying stages 2, 3, 4 are each designed as endless circulating conveyors. The various conveying stages 2, 3, 4 each have a goods intake capacity which decreases as the conveying stage increases. This also applies accordingly to the respective turnaround time of the various conveying stages.

A plurality of loading stations 6 are located upstream of the consolidation storage unit 2. At the loading stations 6, conveyor containers are loaded with, in particular exactly one, product each. The loaded conveyor containers are conveyed from the loading stations 6 into the consolidation storage unit 2.

The first endless conveyor 3 and the second endless conveyor 4 can, in particular, be functionally and/or structurally identical and, in particular, differ only in terms of size and capacity. It is also possible that the endless conveyors 3, 4 differ from each other functionally and/or structurally. The first endless conveyor has, in particular, a main conveyor strand with a fixed entrainment. The fixed entrainment enables a controlled discharge of an ordered product from a conveyor container and/or of the conveyor container from the first endless conveyor 3. In particular, the second endless conveyor 4 is designed as a so-called pack-wall buffer. The pack-wall buffer is a storage element, in particular without fixed entrainment. In the pack-wall buffer, comparatively denser storage and, in particular, recompaction of the goods in the flow of goods is possible, in particular at any point. In terms of its mechanical structure, the pack-wall buffer is similar to the consolidation storage unit, but is designed to be smaller in terms of quantity structure and geometry.

Multiple goods sinks 7 are directly connected to the first endless conveyor 3 in terms of conveying technology. The goods sinks 7 are designed in particular as packing places where orders are packed.

The conveying apparatus 1 has a control unit 8 which is in signal connection with the various conveying stages, i.e., in particular with the consolidation storage unit 2, the first endless conveyor 3 and the second endless conveyor 4 as well as with the loading stations 6 and the goods sinks 7. The signal connection can be established in a wired or wireless manner.

A plurality of reading units 9 are arranged along the conveying apparatus 1, which are indicated purely symbolically in FIG. 1. The reading units 9 are arranged in particular within the respective conveying stages 2, 3, 4 and/or along the conveyor lines 5. It is understood that more or less than the reading units 9 shown in FIG. 1 may be present in the conveying apparatus 1. In particular, the respective position of the reading units 9 in the conveying apparatus 1, in particular along the goods conveying direction, can be variably fixed. The reading units 9 serve to detect the goods, in particular by reading and detecting each individual product, in particular each individual conveyor container in which in particular exactly one product is conveyed in each case. The reading units 9 are each in signal connection with the control unit 8. The detection of the goods is a prerequisite for logical decisions and/or actions based thereon, in particular a targeted discharge of the goods from one conveying stage into the subsequent conveying stage and/or an, in particular automatic, opening of a conveyor container. Correspondingly, the reading units 9 are each arranged upstream of a respective discharge unit of a conveying stage 2, 3, 4.

According to the embodiment example shown, the goods are conveyed in counterclockwise direction in the circulating conveyors 2, 3, 4. The respective goods conveying direction 10 is symbolized by direction arrows. The goods conveying direction 10 is drawn purely symbolically. It is understood that the goods conveying direction could also be oriented clockwise.

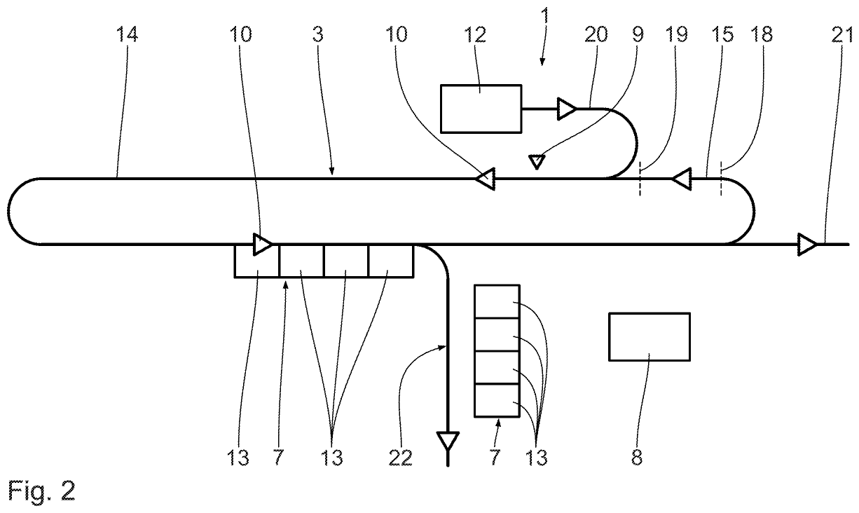

The structure and operating principle of the first endless conveyor 3 are explained in more detail below with reference to FIG. 2.

FIG. 2 shows the conveying apparatus 1 with a goods source 12 and a plurality of goods sinks 7. The conveying apparatus 1 can comprise a plurality of goods sources 12 which are arranged in particular parallel to one another. Each goods sink 7 has in particular a plurality of goods discharge points 13 which are in particular mechanically separated from one another, in particular in the form of partition walls. The goods discharge points 13 at a goods sink 7 can also be designed as separate throw-in shafts having a funnel-shaped goods receptacle which opens upwards in particular.

The goods sinks 7 are in particular packing places at which goods of an order can be packed and in particular handed over to an outgoing goods zone of the conveying apparatus 1 for dispatch.

The goods source 12 and the goods sinks 7 are connected in terms of conveying technology by means of a first endless conveyor 3. The first endless conveyor 3 has an endlessly circulating conveyor line and enables goods to be conveyed along the goods conveying direction 10, which is symbolized by an arrow in FIG. 1 and is oriented in the counterclockwise direction.

The first endless conveyor 3 has a first conveyor strand 14 and a second conveyor strand 15. At the goods source 12, the goods are provided in conveyor containers and conveyed to the goods sinks 7 by means of the conveyor containers. The goods sinks 7 are in particular directly connected to the at least one goods source 12 via the first conveyor strand 14. In particular, exactly one product is arranged in each conveyor container.

The first conveyor strand 14 has a conveyor drive means, not shown in more detail, which enables a fixed conveyor container to be entrained. The conveyor drive means comprises in particular a drive motor and a drive chain 16 that is mechanically coupled thereto. The drive chain 16 is in particular arranged to be guided within a conveyor rail 17 of the first conveyor strand 14, in particular within a guide profile which is in particular made of plastic, and in particular arranged between the second conveyor strand 15 and the first conveyor strand 14.

The first conveyor strand 14 and the second conveyor strand 15 are coupled to each other in terms of conveying technology at two transfer points 18, 19. The first transfer point 18 is arranged in the goods conveying direction 10 between the end of the first conveyor strand 14 and the beginning of the second conveyor strand 15. At the first transfer point 18, the conveyor containers are transferred from the fixed conveyor container entrainment in the first conveyor strand 14 to the second conveyor strand 15 without fixed conveyor container entrainment. At the second transfer point 19, which is arranged in the goods conveying direction 10 between the end of the second conveyor strand 15 and the beginning of the first conveyor strand 14, the goods are transferred from the second conveyor strand 15 to the fixed conveyor container entrainment in the first conveyor strand 14.

The goods source 12 is coupled to the endless conveyor 3 in terms of conveying technology via at least one feed conveyor strand 20, in particular downstream of the second conveyor strand 15 and in particular downstream of the conveyor drive means.

The second conveyor strand 15 is designed in particular as an accumulation conveyor and in particular as a gravity conveyor. It is particularly uncomplicated to design it as a gravity conveyor, which is in particular inclined downwards with respect to the horizontal. The inclination is in particular directed towards the first conveyor strand 14, in particular towards the conveyor drive means. The second conveyor strand 15 has a buffer function.

The conveying apparatus 1 comprises a plurality of goods sinks 7, in particular of different design. The goods sinks 7 can also be of identical design. The goods sinks 7 are spaced apart along the goods conveying direction 10, i.e., one behind the other. A first goods sink 7, shown on the left in FIG. 1, comprises an unloading unit, not shown in more detail, which enables the goods to be unloaded from the conveyor containers, in particular automatically. The first goods sink 7, and in particular the discharge compartments 4, are arranged spatially adjacent to the first conveyor strand 14. The automatic unloading unit can, for example, enable automatic opening or tilting of conveyor bags and/or automatic swivelling or tilting of horizontal conveyor containers, wherein the discharge compartments of the first goods sinks 7 are arranged in the discharge direction of the goods. The first goods sink 7 is thus arranged directly adjacent to the first conveyor strand 14.

Downstream of the goods sinks 7, a discharge line 21 is connected to the endless conveyor 3. The discharge line 21 serves to discharge, in particular automatically, emptied conveyor containers from the endless conveyor 3. The discharge line 21 leads in particular to a loading station that is not shown, at which the conveyor containers can be loaded with goods. The discharge line 21 can in particular also be connected to a buffer storage unit in order to temporarily store empty conveyor containers.

The discharge line 21 can be omitted, in particular if automatic emptying of the conveyor containers by means of an unloading unit does not take place.

A second goods sink 7 shown on the right in FIG. 1 is connected to the endless conveyor 3, in particular to the first conveyor strand 14, by means of a discharge unit 22. The second goods sink 7 can be arranged at a spatial distance from the first conveyor strand 14, wherein a connection in terms of conveying technology to the first conveyor strand 14 is ensured by means of the discharge unit 22. The discharge unit 22 is in particular designed to be identical to the discharge line 21. The discharge unit 22 enables the targeted discharge of conveyor containers from the endless conveyor 3 into the discharge unit 22. In the region of the second goods sink 7, the conveyor containers are stopped by means of a stopper, which is not shown in more detail, and then unloaded, in particular manually. It is conceivable that the discharge unit 22 leads to a loading station analogously to the discharge line 21. It is also conceivable that the discharge unit 22 merges with the discharge line 21 or that the discharge unit 22 opens into the discharge line 21. In particular, a plurality of discharge units 22 can be connected to the endless conveyor 3. It is advantageous if either a discharge unit 22 or an unloading unit is provided for every second goods sink 7.

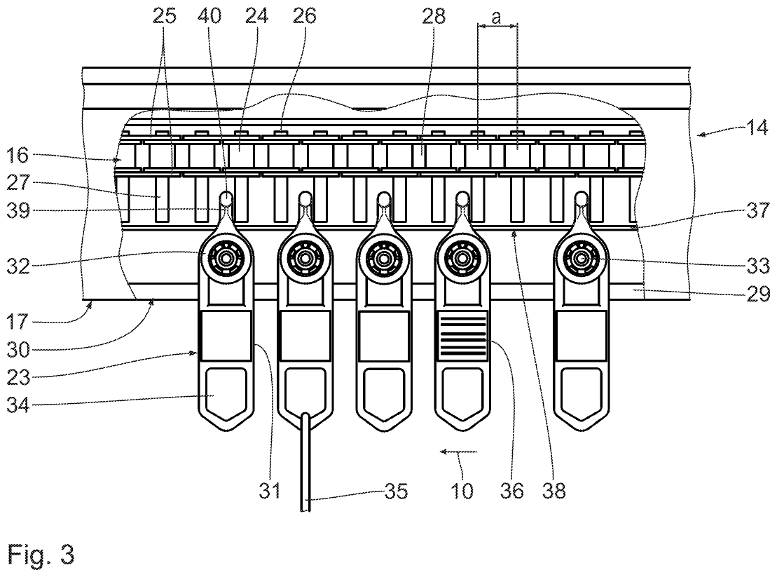

In the following, the first conveyor strand 14 is explained in more detail with reference to FIG. 3.

The first conveyor strand 14 is designed as a conveyor rail 17, which is also referred to as a transport rail. Accordingly, the conveying apparatus 1 is an overhead conveyor. The transport rail 17 can be moved in a room by means of suitable carrying devices. The transport rail 17 is designed as a hollow box profile in which a drive chain 16 is arranged and can be driven in the goods conveying direction 10 by means of the drive that is not shown purely schematically in FIG. 3.

Holding members 23 can be moved along the transport rail 17 by means of the drive chain 16. The drive chain 16 and the drive, not shown, form a conveyor drive means for the first conveyor strand 14. The drive is in particular an electric motor drive which is mechanically coupled to the drive chain 16, i.e., for power transmission, by means of a power transmission member, in particular a drive gearwheel.

The drive chain 16 is a so-called roller chain with rollers 24, which are connected to each other at a small distance from one another by means of connection pieces 25. Bolts 26 have downwardly projecting bolt-shaped extensions serving as entrainers 27. The bolts 26 with the entrainers 27 extend normally to the transport rail 17 in a vertical plane that is spanned by the goods conveying direction 10.

The drive chain 16 is guided and held in the transport rail 17 in the direction of the bolts 26, i.e., perpendicularly and transversely to the goods conveying direction 10 by means of guides 28 engaging under the connection pieces 17.

A centre-to-centre distance a between adjacent entrainers 27 in the transport rail 17 in the goods conveying direction 10 corresponds exactly to the pitch of the drive chain 16 and is therefore invariable and constant. The entrainers 27 define the fixed conveyor container entrainment.

On an underside of the transport rail 17, two guiding webs 29 are formed facing each other, between which a slot 30 extending in the longitudinal direction of the transport rail 17, i.e., in the goods conveying direction 10, is formed or defined. A flat supporting part 31 of each holding member 23 projects downwards out of the transport rail 17 through said slot 30. In its upper region, the holding member 23 has a caster 32 on each side of the supporting part 31, each of which is supported on one of the two guiding webs 29 and can be displaced thereon in the goods conveying direction 10. There is therefore only one pair of casters 32 which can rotate around a common axis 33 so that the entire holding member 23 can oscillate about the axis 33 in the transport rail 17.

The supporting part 31 has a receiving opening 34 at its lower end into which a conveyor container in the form of a conveyor bag 35 can be suspended. The conveyor bag 35 is shown purely schematically in FIG. 2. The holding member 23, which is conveyed to roll in the transport rail 17 by means of the casters 32 and which is suitable for receiving the conveyor bag 35 by means of the receiving opening 34, is also referred to as a roller adapter.

The holding member 23 has an identification member 36 that is designed as a transponder, in particular an RFID chip, or as a machine-readable code, in particular a barcode or QR code. The identification member 36 is arranged in particular between the receiving opening 34 and the underside of the transport rail 17 and can thus be read by a reading device, in particular in an automated manner. The identification member 36 extends in accordance with the arrangement of the plate-like supporting part 31 in the goods conveying direction 10, i.e., its main surface lies open transversely to the goods conveying direction 10, i.e., towards the side.

After being mechanically coupled to the holding member 23, the conveyor bag 35 with goods to be conveyed remains attached to the holding member 23 during the entire conveying process, i.e., it is “married” to the latter. The goods to be conveyed are therefore controlled via the identification member 36 and thus the holding member 23. Since again the entire transport is performed from the drive chain, it is very important that a holding member 23 assumes an absolutely unambiguous position relative to the drive chain 16 during transport.

The transport rail 17 has horizontal boundary webs 37 facing each other directly above the casters 32, which delimit a slot 38 in between. A stalk-like projection 39 of the holding member 23 extends through this slot 38 and is formed integrally with the supporting part 31 at the upper end thereof.

At the upper end of the stalk-like projection 39, a stop 40 is formed in the manner of a transverse bar, the extension of which horizontally transverse to the goods conveying direction 10 is greater than the width of the slot 38, so that when the holding member 23 is inclined relative to the transport rail 17, this stop 40 comes to rest on the boundary webs 37 and thus prevents further inclination of the holding member 23. The projection 39 and the stop 40 have the basic shape of a hammer, i.e., they are T-shaped.

The entrainers 27 of the drive chain 16 extend to immediately above the boundary webs 37, so that a holding member 23 located between two entrainers 27 is always reliably entrained, i.e., does not become disengaged from the entrainer 27.

The control unit 8 is in signal connection in particular with the at least one goods source 12, the goods sinks 7, the first endless conveyor 3 and/or the conveyor strands 14 and 15. In particular, the control unit 8 is in signal connection with the conveyor drive means in order to enable a targeted introduction of the conveyor bags 35 from the at least one goods source 12 or a return of the conveyor bags 35 from the second conveyor strand 15.

A reading unit 9 is arranged in particular at the entrance of the endless conveyor 3, i.e., where the feed conveyor strand 20 opens into the endless conveyor 3. A further reading unit 9 can be arranged in particular at the exit of the endless conveyor 3, i.e., where the discharge line 21 opens out from the endless conveyor 4. The reading units 9 serve to read the endless conveyor 4, so that direct conclusions can be drawn about the respective position of the conveyor bags 35 in the conveying apparatus 1 and in particular within the endless conveyor 3.

In particular, the control unit 8 is in signal connection with the unloading unit and/or with the discharge unit 22 in order to ensure automatic unloading and/or discharge of the conveyor bags 35.

A conveying method for goods in the conveying apparatus 1 is explained in more detail below. In the conveying apparatus 1, goods are loaded into conveyor containers 35 at the loading stations 6 and transferred to the consolidation storage unit 2. The goods are conveyed in circulation in the consolidation storage unit 2 and, if necessary, discharged and conveyed via the conveyor line 5 first to the second endless conveyor 4 and, if necessary, via the further conveyor line 5 to the first endless conveyor 3. From the first endless conveyor 3, the goods of an order are conveyed as ordered goods to one of the goods sinks 7, where they are packed and prepared for dispatch and, in particular, delivered to an outgoing goods zone not shown.

It is now essential that, counter to the conveying direction 10 of the goods, there is a demand direction of the goods starting from the goods sinks 7.

An order containing at least one ordered product is allocated to each of the goods sinks 7, thereby triggering a request for ordered goods at this goods sink 7. This request for goods is triggered as a goods request notification from the goods sink 7 to the first endless conveyor 3 by means of the control unit 8. The goods request notification 11 is in particular a control signal that is output by the control unit 8 and transmitted to the first endless conveyor 3. Accordingly, further goods requirement notifications are issued to the respective next upstream conveying stage. The goods request notifications 11 are symbolized by the direction arrows in FIG. 1.

In particular, the various requests can be quantity-based, priority-based and/or customer-based.

What is claimed is:

1. A conveying method for goods, the method comprising:
requesting an order from a goods sink, wherein the order comprises at least one product, which is an ordered product;
requesting the at least one product from a first endless conveyor, to which the goods sink is directly coupled;
requesting the at least one product from a consolidation storage unit upstream of the first endless conveyor, the storage unit including a circulating conveyor line;
automatically transferring the at least one product to the first endless conveyor; and
conveying the at least one ordered product to the goods sink.

2. The conveying method according to claim 1, wherein the conveying includes conveying the at least one product in a conveyor container.

3. The conveying method according to claim 2, wherein the conveying includes conveying the at least one product individually in the conveyor container.

4. The conveying method according to claim 2, wherein conveying the at least one product includes at least one of unloading the at least one product from the conveyor container and discharging of conveyor containers from the first endless conveyor.

5. The conveying method according to claim 4, wherein the unloading is an automatic unloading.

6. The conveying method according to claim 1, wherein requesting the at least one product includes requesting based on at least one of a criteria of order quantity, customer of the order, and order priority.

7. The conveying method according to claim 6, wherein the criteria are variable for different conveying stages.

8. The conveying method according to claim 1, wherein the requesting the at least one product includes requesting from a second endless conveyor downstream of the consolidation storage unit.

9. The conveying method according to claim 8, wherein the requesting the at least one product includes requesting from the second endless conveyor prior to requesting from the consolidation storage unit.

10. The conveying method according to claim 1, wherein the at least one product is a collection of ordered goods of an order in a conveying stage.

11. The conveying method according to claim 10, wherein the at least one product is a collection of ordered goods of an order in the consolidation storage unit.

12. The conveying method according to claim 1, further including changing an order sequence when requesting goods.

13. The conveying method according to claim 1, wherein conveying the at least one product includes conveying the at least one product into the first endless conveyor.

14. The conveying method according to claim 1, wherein conveying the at least one product includes only conveying the at least one product to a next conveying stage if all ordered goods of this order are arranged in the previous conveying stage.

15. The conveying method according to claim 1, wherein conveying the at least one product includes only conveying the at least one product to the a conveying stage if all ordered goods of this order are arranged in the consolidation storage unit.

16. The conveying method according to claim 1, further comprising filling the consolidation storage unit with goods from at least one loading station.

17. The conveying method according to claim 1, further comprising providing random access to all goods in at least one of the first endless conveyor, the second endless conveyor, and the consolidation storage unit.

18. The conveying method according to claim 1, further comprising providing random access to all goods in each conveying stage.

19. A conveying apparatus for goods, the apparatus comprising:
a consolidation storage unit having a circulating conveyor line;
a first endless conveyor arranged downstream of the consolidation storage unit;
at least one goods sink directly coupled to the first endless conveyor; and
a control unit configured to execute conveyance of goods.

20. The conveying apparatus according to claim 19, comprising a second endless conveyor arranged between the consolidation storage unit and the first endless conveyor.

21. The conveying apparatus according to claim 19, wherein the conveying apparatus is an overhead conveying apparatus.

22. The conveying apparatus according to claim 19, wherein the conveying apparatus includes a conveyor rail and entrainers that are conveyable thereon, each of which is couplable to a conveyor container.

23. The conveying apparatus according to claim 19, wherein the first endless conveyor and the consolidation storage unit are configured such that an intake capacity thereof decreases as the conveying stage increases.

24. The conveying apparatus according to claim 19, wherein the second endless conveyor is configured such that an intake capacity thereof decreases as the conveying stage increases.

25. A conveying method for goods, the method comprising:
requesting an order from a goods sink, wherein the order comprises at least one product, which is an ordered product;
requesting the at least one product from a consolidation storage unit upstream of an endless conveyor, the storage unit including a circulating conveyor line;
automatically transferring the at least one product to the first endless conveyor; and
conveying the at least one ordered product to the goods sink.
